(19) United States
(12) Patent Application Publication
(10) Pub. No.: US 2022/0300866 A1
(43) Pub. Date: Sep. 22, 2022

(54) CONCIERGE ONLINE MOVIE TICKET PURCHASE AND RESERVATION SYSTEMS AND METHODS

(71) Applicant: HOLLYWOOD.COM LLC, Boca Raton, FL (US)

(72) Inventors: Jerome POWELL, Boca Raton, FL (US); Greg SICA, Boca Raton, FL (US); Scott MCDONALD, Boca Raton, FL (US)

(21) Appl. No.: 17/633,157

(22) PCT Filed: Aug. 28, 2020
(86) PCT No.: PCT/US2020/048508

§ 371 Date: Feb. 4, 2022

Related U.S. Application Data
(60) Provisional application No. 62/893,591, filed on Aug. 29, 2019.

(51) Int. Cl. G06Q 10/02; G06Q 20/10; G06Q 30/06

(52) U.S. Cl. CPC G06Q 10/02; G06Q 20/10; G06Q 30/0641

(57) ABSTRACT

A method performed by a concierge service implemented by at least one server computing device. The method includes receiving an indication from a user. The indication indicates that the user would like to purchase one or more movie tickets for a particular showtime of a movie or that the user would like to reserve one or more movie tickets for a movie that has not yet been released and for which tickets are not yet available for purchase. If the former, the concierge service completes the purchase of the movie ticket(s) for the particular showtime. If the later, the concierge service creates a ticket reservation by freezing user funds corresponding to a price of the movie ticket(s) when the movie has not yet been released, purchases the movie ticket(s) for the user after the tickets are made available for purchase, and collects the funds that were frozen.

### CROSS REFERENCE TO RELATED APPLICATION

This application claims the benefit of U.S. Provisional Application No. 62/893,591, filed on Aug. 29, 2019, which is incorporated herein by reference in its entirety.

### BACKGROUND OF THE INVENTION

### Field of the Invention

The present invention is directed generally to systems for and methods of purchasing and/or reserving movie tickets online.

### Description of the Related Art

Users face challenges when attempting to buy movie tickets in advance including, but not limited to, high-volume scenarios and difficulty identifying showtimes that match their specific criteria. Identifying showtimes is complicated by the fact that there can be a large number of (e.g., as many as 30) different showtimes for a specific movie on a given day. During a high-volume scenario, a large number of users are attempting to buy movie tickets for a specific movie (e.g., a blockbuster) and consequently overload the online point of sale system operated by the exhibitor. As a result, the online point of sale system slows to a snail's pace causing a frustrating user experience and/or, as occurs in many cases, the online point of sale system experiences a complete system failure.

### BRIEF DESCRIPTION OF THE SEVERAL VIEWS OF THE DRAWINGS

Various embodiments in accordance with the present disclosure will be described with reference to the following drawings.

FIG. 1 is a block diagram of a system for purchasing and/or reserving movie tickets that includes a plurality of client computing devices.

FIG. 2 is a flow diagram of a method performed at least in part by the system of FIG. 1 after a user launches an application on one of the client computing devices.

FIG. 3 is a flow diagram of a method performed at least in part by the system of FIG. 1 that implements an onboarding process.

FIG. 4 is a flow diagram of a method of purchasing movie tickets that are currently on sale performed at least in part by the system of FIG. 1.

FIG. 5 is a flow diagram of a method performed at least in part by the system of FIG. 1 when the onboarding process was completed previously.

FIG. 6 is a flow diagram of a method of confirming and paying for movie tickets performed at least in part by the system of FIG. 1.

FIG. 7 is a flow diagram of a method of reserving tickets that are not currently on sale performed at least in part by the system of FIG. 1.

FIG. 8 is a flow diagram of a method of purchasing previously reserved tickets when the tickets go on sale that is performed at least in part by the system of FIG. 1.

FIG. 9 is an illustration of an embodiment of a Concierge view page.

FIG. 10 is a functional block diagram illustrating a mobile communication device that may be used to implement one or more of the plurality of client computing devices of FIG. 1.

FIG. 11 is a diagram of hardware and an operating environment in conjunction with which implementations of the one or more computing devices of the system of FIG. 1 may be practiced.

Like reference numerals have been used in the figures to identify like components.

### DETAILED DESCRIPTION OF THE INVENTION

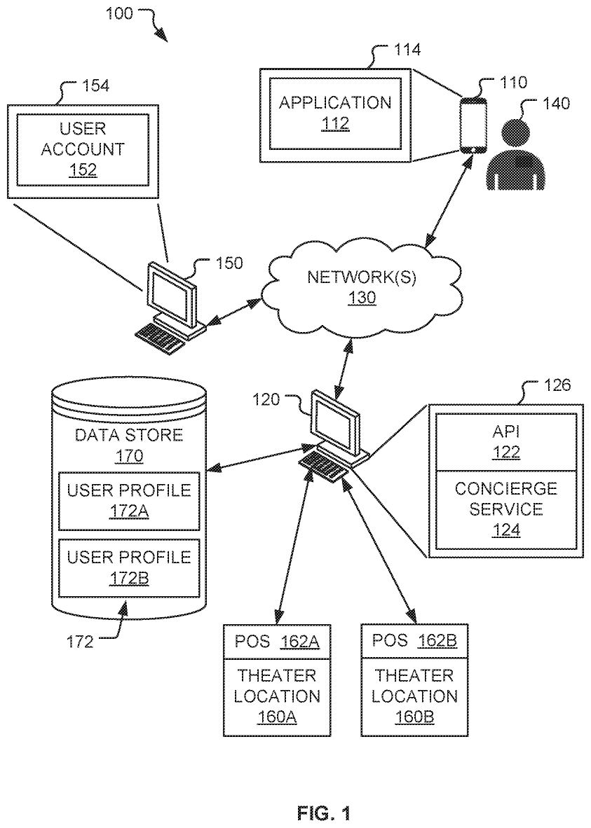

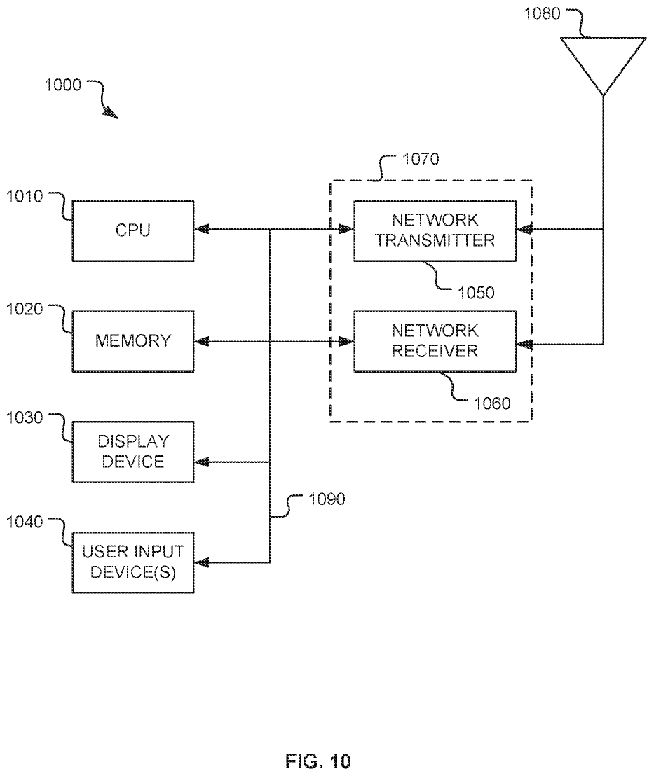

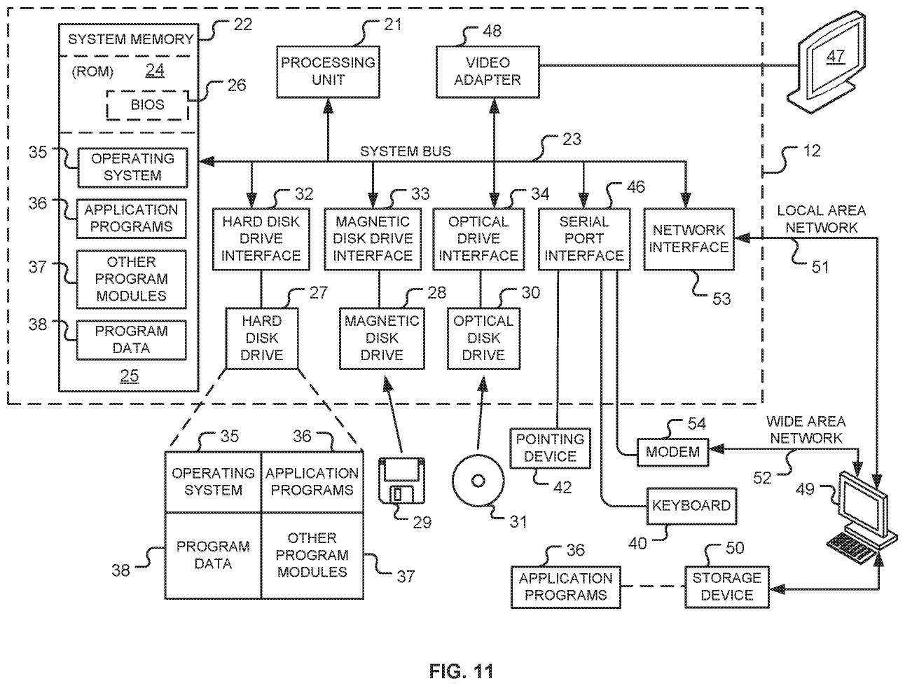

FIG. 1 is a diagram of a system 100 for purchasing and/or reserving movie tickets. The system 100 includes a plurality of client computing devices (e.g., a client computing device 110) connected to at least one server computing device (e.g., a server computing device 120) by one or more networks 130. In FIG. 1, for simplicity, the plurality of client computing devices have been illustrated and will be described as including only the client computing device 110. However, the plurality of client computing devices may include any number of client computing devices each like the client computing device 110. By way of a non-limiting example, the client computing device 110 may be implemented as a mobile communication device 1000 (see FIG. 10) or a computing device 12 (see FIG. 11), Also, in FIG. 1, for simplicity, the server computing device(s) has/have been illustrated and will be described as including only the server computing device 120. However, the server computing device(s) may include any number of server computing devices each like the server computing device 120. The server computing device 120 may be implemented as one or more computing devices (e.g., each like the computing device 12 illustrated in FIG. 11), Referring to FIG. 1, the server computing device 120 may implement and/or be connected to a data store 170 (e.g., a database). The data store 170 may be implemented by one or more computing devices (e.g., each like the computing device 12 illustrated in FIG. 11).

The system 100 may include or be connected to a payment processor service 150. The payment processor service 150 may be implemented by one or more computing devices (e.g., each like the computing device 12 illustrated in FIG. 11). The server computing device 120 is configured to communicate with the payment processor service 150 (e.g., via the network(s) 130). The payment processor service 150 is configured to communicate (1) funds or some other financial arrangement (e.g., made in advance), or (2) a refusal of funds to the server computing device 120. The payment processor service 150 may implement or be connected to a plurality of user accounts (e.g., a user account 152) for a plurality of users (e.g., a user 140). The user accounts may be stored in memory 154 (e.g., implemented as system memory 22 illustrated in FIG. 11) of the computing device(s) that implement the payment processor service 150.

The server computing device 120 may be in communication with any number of movie theatre locations (e.g., movie theatre locations 160A and 160B). Alternatively, personnel at an entity (not shown) operating the server computing device 120 may be in communication with the movie theatre locations 160A and 160B. The theatre locations 160A and 160B may include or be associated with point-of-sale (“POS”) systems 162A and 162B, respectively. Each of the POS systems 162A and 162B is configured to receive and complete a movie ticket order. By way of a non-limiting example, the server computing device 120 may communicate with the POS systems 162A and 162B via the network(s) 130.

The client computing device 110 is configured to be operated by the user 140. The client computing device 110 implements an application 112 that may be stored in memory 114 of the client computing device 110 (e.g., implemented as the memory 1020 illustrated in FIG. 10 or system memory 22 illustrated in FIG. 11). By way of a non-limiting example, the application 112 may be downloaded from the server computing device 120 or an application store (not shown) and installed on the client computing device 110.

The server computing device 120 implements an application programming interface (“API”) 122 that may be stored in memory 126 of the server computing device 120 (e.g., implemented as the system memory 22 illustrated in FIG. 11). The API 122 allows the application 112 to access functionality provided by a virtual Concierge service 124 that may be implemented by the server computing device 120 and/or one or more other computing devices like the server computing device 120. Functionality attributed to the API 122 below may be performed at least in part by the virtual Concierge service 124.

The virtual Concierge service 124 stores (e.g., in the data store 170) a plurality of user profiles 172 defined by the plurality of users. In the example illustrated, the virtual Concierge service 124 has stored user profiles 172A and 172B both associated with the user 140. The virtual Concierge service 124 may store identifications of one or more movies that have been tagged by the user 140 and associated with one of the user profiles 172A and 172B by the user 140.

The virtual Concierge service 124 allows moviegoers (e.g., the user 140) to quickly purchase movie tickets that match their predefined criteria or user preferences. Based on user inputs, the virtual Concierge service 124 may present each of the users (e.g., the user 140) with a list of movie choices that match the time, theatre, date, number of tickets, preferred seating, and other attributes (e.g., IMAX or 3D) that the user can quickly scan and use to purchase movie tickets. Thus, the virtual Concierge service 124 eliminates the need for the user 140 to go through the traditional online movie purchasing experience whereby the user must select each of the following each time tickets are purchased:
1. A theatre,
2. A movie,
3. A date,
4. A showtime,
5. Seats,
6. A ticket type, and
7. Ticket quantity.

The virtual Concierge service 124 takes advantage of the fact that moviegoers tend to be creatures of habit. For example, the virtual Concierge service 124 saves user preferences (or selections with regard to each of the above, except movie) and uses these preferences to build a user profile (e.g., the user profile172A). When the user 140 selects a movie, the virtual Concierge service 124 matches showtime information for the selected movie with the user profile, and flags those showtimes satisfying the user's preferences. This allows the user 140 to quickly complete a ticket order (e.g., with a purchase button call to action) and eliminates the need for the user 140 to re-enter information that the user 140 likely entered during previous ticket purchasing transactions.

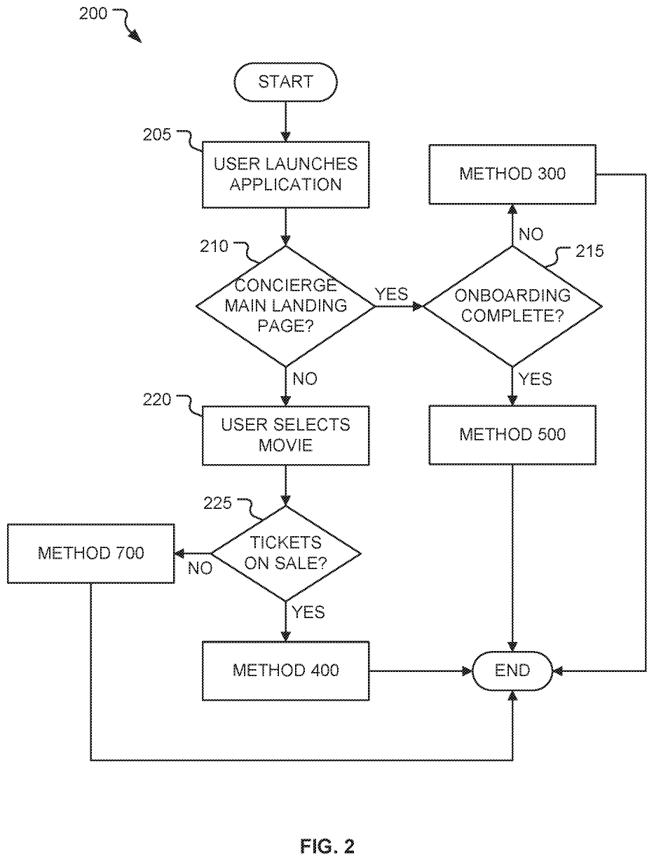

FIG. 2 is a flow diagram of a method 200 performed in part by the user 140 (see FIGS. 1), in part by the application 112 (see FIGS. 1), and in part by the API 122 (see FIGS. 1). In first block 205, the user 140 launches the application 112 on the client computing device 110 (see FIGS. 1). The user 140 uses the application 112 to access and use the virtual Concierge service 124 (see FIGS. 1). For example, the user 140 may use the application 112 to navigate to one or more screens or pages (not shown) generated by the virtual Concierge service 124.

A decision in decision block 210 is “YES,” when the user 140 has used the application 112 to navigate to a Concierge main landing page (not shown) that is generated by the virtual Concierge service 124 and is displayable by the application 112. Otherwise, the decision in decision block 210 is “NO.”

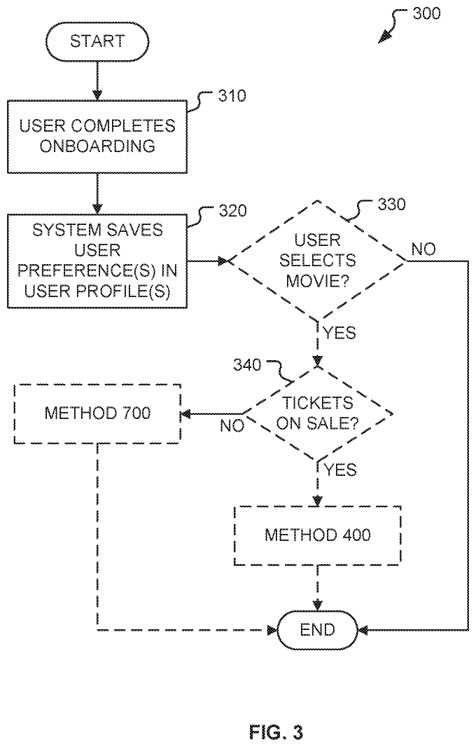

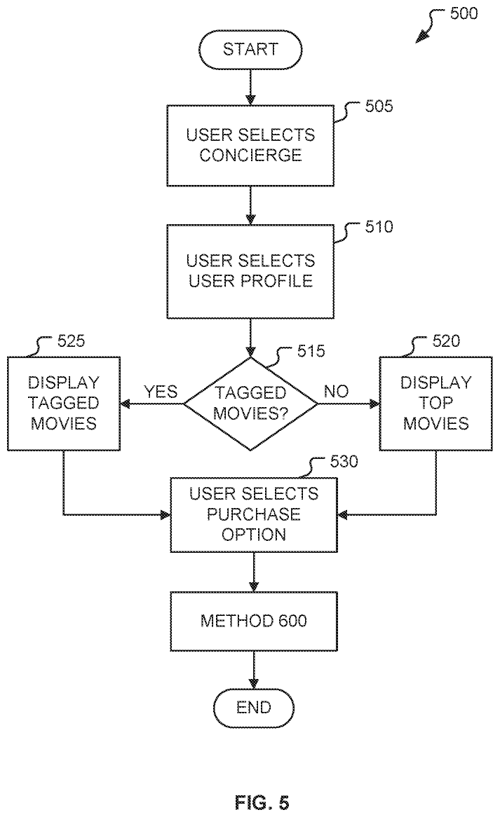

When the decision in decision block 210 is “YES,” the API 122 advances to decision block 215 in which the API 122 decides if the user 140 has completed an onboarding process. The decision in decision block 215 is “YES,” when the user 140 has completed the onboarding process. Otherwise, the decision in decision block 215 is “NO.” When the decision in decision block 215 is “NO,” a method 300 (see FIG. 3) is performed and the method 200 terminates. On the other hand, when the decision in decision block 215 is “YES,” a method 500 (see FIG. 5) is performed and the method 200 terminates.

When the decision in decision block 210 is “NO,” the user 140 selects a movie in block 220. The user 140 uses the application 112 to select the movie and the application 112 communicates this selection to the API 122. This selection may be considered as having tagged the selected movie.

In decision block 225, the API 122 decides whether tickets for the selected movie are currently on sale. The decision in decision block 225 is “YES,” when tickets for the selected movie are currently on sale. Otherwise, the decision in decision block 225 is “NO.”

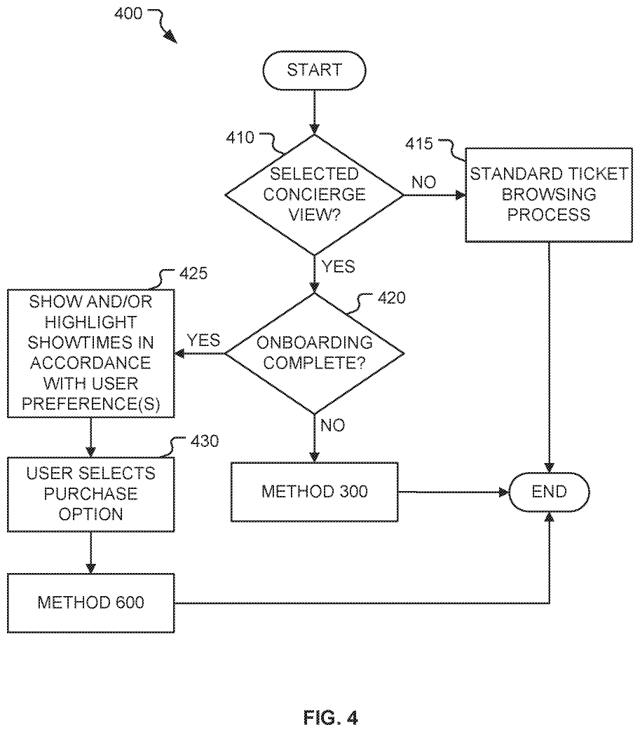

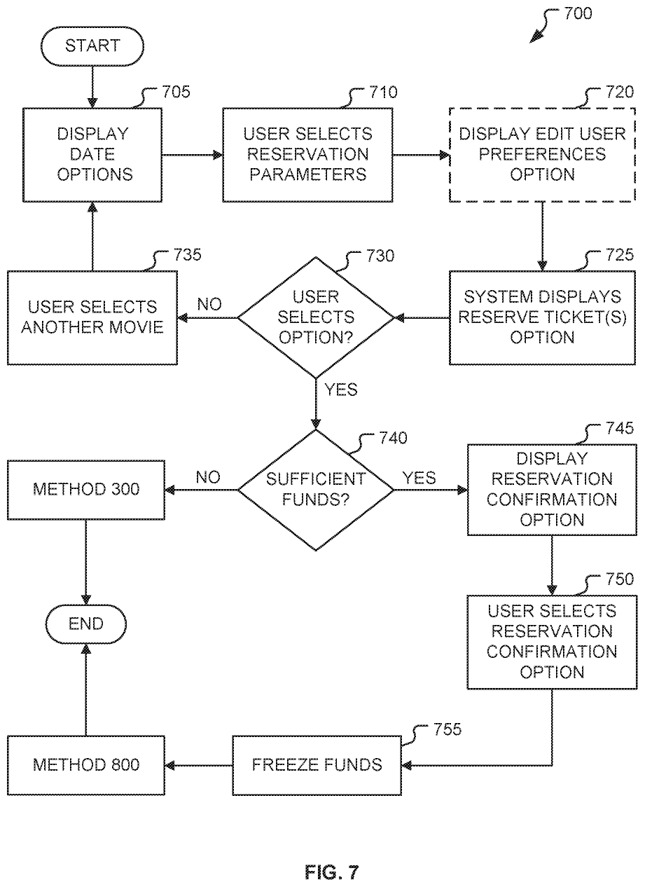

When decision in decision block 225 is “YES,” the method 400 (see FIG. 4) is performed and the method 200 terminates. On the other hand, when the decision in decision block 225 is “NO,” the method 700 (see FIG. 7) is performed and the method 200 terminates.

FIG. 3 is a flow diagram of the method 300 performed in part by the user 140 (see FIG. 1), in part by the application 112 (see FIG. 1), and in part by the API 122 (see FIG. 1). In first block 310, the user 140 completes the onboarding process. Referring to FIG. 1, during the onboarding process, the user 140 creates one or more user profiles and inputs one or more user preferences for each user profile. For example, the user 140 may create the user profile 172A as a “Parents” profile for adult members of a household and the user profile 172B as a “Kids” profile for child members of the same household. By way of a non-limiting example, the user 140 may enter or select the following information for each of the user profiles 172A and 172B during the onboarding process:
1. One or more favorite theatre locations;
2. Preferred time of day for showtimes (e.g., midday, evening, night, or late night);
3. Preferred day or days of the week for showtimes;
4. Seating preference(s) (e.g., front, middle, rear, left, middle, and/or right);
5. Number of tickets and ticket types (e.g., adult tickets, senior tickets, etc.);
6. Premium features (IMAX, 3D, etc.);
7. Loyalty program information;
8. Prepayment information (e.g., credit card information); and
9. User profile identifier (e.g., “Date Night” or “Family Night”).

During the onboarding process, the user 140 may create the user account 152 and prepay funds into the user account 152. The user account 152 may be associated with the user profiles 172A and 172B associated with the user 140.

For ease of illustration, in block 310 (see FIG. 3), the user 140 will be described as having entered or selected information that the virtual Concierge service 124 uses to create the user profile 172B. In block 320 (see FIG. 3), the

API 122 communicates this information (including one or more user preferences) to the virtual Concierge service 124, which creates the user profile 172B and stores the user preference(s) therein. The virtual Concierge service 124 also associates the user profile 172B with the user 140 and the user account 152.

The user 140 may specify one of the user profiles 172A and 172B as a default user profile and/or select one of the user profiles 172A and 172B as a selected user profile for the current session. Whenever the user 140 has not selected a user profile, the default user profile is the selected user profile. For ease of illustration, the user profile 172A will be described as being the selected user profile 172A.

The user 140 may also tag one or more movies and associate the tagged movies with at least one of the user profiles 172A and 172B. Movies may be tagged and associated with a particular user profile (e.g., the selected user profile 172A) at any time after the particular user profile has been created. Movies may be tagged by the user 140 in the application 112, a website operated by the virtual Concierge service 124, or offsite (e.g. via a browser add-on such as a Chrome extension, a website operated by a partner, a Voice assistant, etc.).

Optionally, at this point, the user 140 may select a movie for which the user 140 wishes to reserve or purchase tickets. Referring to FIG. 3, the decision in optional decision block 330 is “NO” when the user 140 (see FIG. 1) does not select a movie and the method 300 terminates. Further, if optional decision block 330 is omitted from the method 300, the method 300 terminates.

On the other hand, the decision in optional decision block 330 is “YES,” when the user 140 (see FIG. 1) has selected a movie. When the decision in optional decision block 330 is “YES,” in optional decision block 340, the API 122 (see FIG. 1) decides whether tickets for the movie selected are currently on sale. The decision in optional decision block 340 is “YES” when tickets for the movie selected are currently on sale. Otherwise, the decision in optional decision block 340 is “NO.”

When decision in optional decision block 340 is “YES,” the method 400 (see FIG. 4) is performed and the method 300 terminates. On the other hand when the decision in optional decision block 320 is “NO,” the method 700 (see FIG. 7) is performed and the method 300 terminates.

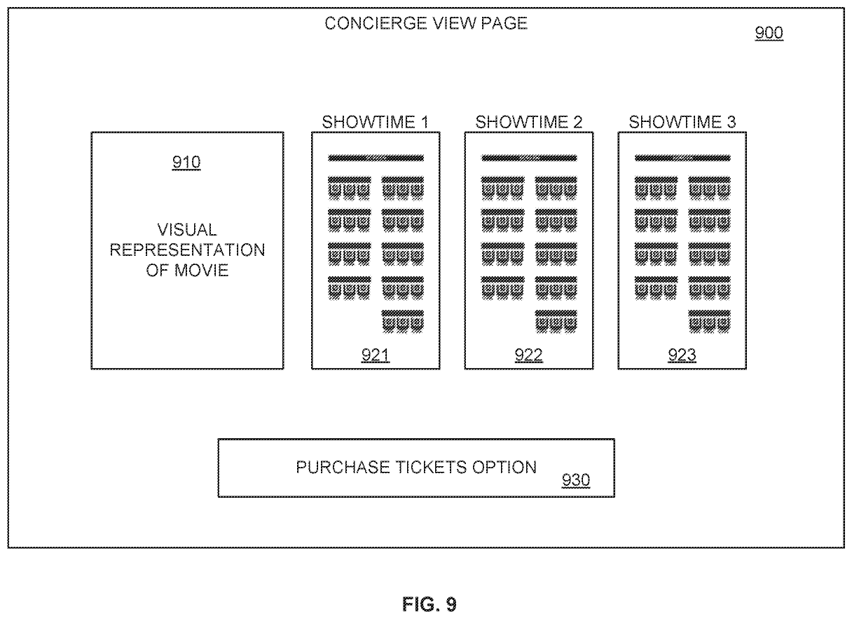

FIG. 4 is a flow diagram of the method 400 performed in part by the user 140 (see FIG. 1), in part by the application 112 (see FIG. 1), and in part by the API 122 (see FIG. 1). Before the method 400 is performed, the user 140 has selected a movie for which tickets are currently on sale. As mentioned above, the user 140 may use the application 112 to navigate to one or more screens or pages generated by the virtual Concierge service 124 (see FIG. 1). In decision block 410, the API 122 decides if the user 140 has used the application 112 to navigate to a Concierge view page 900 (see FIG. 9) generated by the virtual Concierge service 124. The decision in decision block 410 is “YES,” when the user 140 has navigated to the Concierge view page 900 (see FIG. 9). Otherwise, the decision in decision block 410 is “NO,”

When the decision in decision block 410 is “NO,” the user 140 may continue through a standard ticket browsing process in block 415. Then, the method 400 terminates. On the other hand, when the decision in decision block 410 is “YES,” the API 122 advances to decision block 420.

In decision block 420, the API 122 decides if the user 140 has completed the onboarding process. The decision in decision block 420 is “YES,” when the user 140 has completed the onboarding process. Otherwise, the decision in decision block 420 is “NO.”

When the decision in decision block 420 is “NO,” the method 300 (see FIG. 3) is performed and the method 400 terminates. On the other hand, when the decision in decision block 420 is “YES,” in block 425, the API 122 instructs the application 112 to display the Concierge view page 900 (see FIG. 9). Referring to FIG. 9, the Concierge view page 900 displays and/or highlights those showtimes for the selected movie that satisfy the user's user preference(s) specified in the selected user profile 172A (see FIG. 1). For example, on the Concierge view page 900, those showtime options that match the user preference(s) specified in the selected user profile 172A may be highlighted and/or those showtimes that do not match the user preference(s) may be filtered and not displayed. By way of another non-limiting example, the showtimes may be ranked and/or scored based on how closely they match the user preference(s) in the selected user profile 172A.

Table 1 (below) is an example of how the movies (listed in first column) may be color coded (e.g., green or gray) on the Concierge view page 900 depending upon whether the tagged movie has at least one showtime that is showing in the preferred theatre, has preferred seats available, is showing at the preferred time, and or has the preferred number of tickets available. In Table 1, a checkmark in a cell indicates that the user preference in the first row, which is above the cell, is satisfied for the movie in the first column, which is to the left of the cell.

TABLE 1

| Tagged | Preferred | Preferred | Preferred | Preferred No. | |
|---|---|---|---|---|---|
| Movies | theatre | seats | time | of tickets | Score |
| Movie 1 | ✓ | ✓ | ✓ | ✓ | Green |
| Movie 2 | | ✓ | ✓ | ✓ | Gray |
| Movie 3 | ✓ | | ✓ | | Gray |

In the example illustrated in Table 1 (above), Movie 1 is the only movie listed that satisfies all of the user preferences in the selected user profile 172A. Thus, only Movie 1 will be highlighted in the color green. The other movies listed will appear highlighted in the color gray. The Concierge view page 900 may include an option to select a particular showtime, The Concierge view page 900 may also display or provide a link to a seating chart that the user 140 may use to select one or more seats for the selected showtime. The Concierge view page 900 includes a purchase (or reserve) tickets option 930 that the user 140 may select to purchase the movie tickets for the select seats and the selected showtime,

FIG. 9 depicts an alternate presentation that may be used by the Concierge view page 900. In FIG. 9, the Concierge view page 900 displays a visual representation 910 of a movie (e.g., a movie poster) with showtimes that match the user preference(s) in the selected user profile 172A along with links 921-923 to seating charts (e.g., previews of seating layouts) for each of those showtimes. In other words, in FIG. 9, each of the links 921-923 represents a different showtime that matches the user preference(s) stored in the selected user profile 172A. The user 140 may select one of the links 921-923 to thereby select a particular showtime and checkout or edit the seat selection, if desired. Alternatively, the user 140 may highlight one of the showtimes to select it and select the purchase tickets option 930 to checkout.

Using the visual scoring system of Table 1 (above) or the alternate presentation depicted in FIG. 9, the user 140 may quickly see if there are any showtimes for a particular movie that match their user preferences so the user 140 can buy the desired tickets, In block 430 (see FIG. 4), the user 140 selects a showtime, and optionally selects one or more seats. The user 140 may also select a number of tickets, and a type of ticket if these parameters were not specified in the selected user profile 172A or if the user 140 wishes to choose a different value than is specified in the selected user profile 172A. Then, the user 140 selects the purchase tickets option 930 on the Concierge view page 900. The purchase tickets option 930 may be implemented as a one-click buy option.

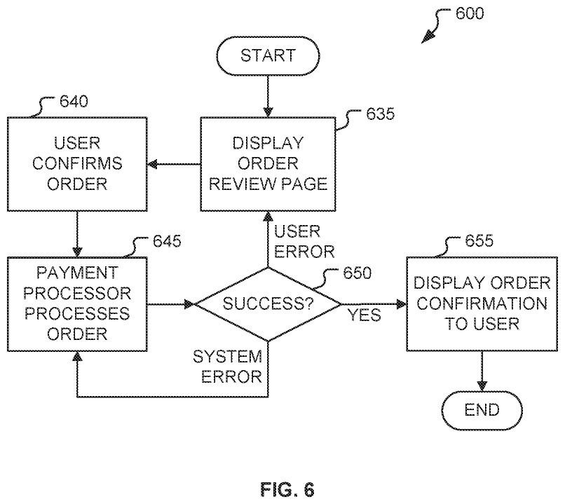

Referring to FIG. 4, next, a method 600 (see FIG. 6) is performed and the method 400 terminates.

FIG. 5 is a flow diagram of the method 500 performed in part by the user 140 (see FIG. 1), in part by the application 112 (see FIG. 1), and in part by the API 122 (see FIG. 1). In first block 505, the user 140 selects the virtual Concierge service 124. When this occurs, the API 122 instructs the application 112 to display a user profile selection page (not shown) to the user 140. As explained above, the user 140 may create multiple user profiles (e.g., the user profiles 172A and 172B) that are each associated with the user 140.

In block 510, the user 140 selects the user profile 172A from the user profile selection page (not shown). Then, in decision block 515, the API 122 determines whether the user 140 has tagged one or more movies and associated the tagged movie(s) with the selected user profile 172A. The decision in decision block 515 is “YES,” when the user 140 has tagged one or more movies and associated the tagged movie(s) with the selected user profile 172A. Otherwise, the decision in decision block 515 is “NO.”

When the decision in decision block 515 is “NO,” in block 520, the API 122 instructs the application 112 to display the Concierge view page 900 (see FIG. 9), which displays those showtimes for a number (e.g., three) of the top (e.g., most popular) movies that satisfy the user's user preference(s) specified in the selected user profile 172A. The Concierge view page 900 (see FIG. 9) may display a message to the user 140 explaining that the number of top movies are being displayed because the user 140 has not tagged any movies that is/are associated with the selected user profile 172A. Then, the user 140 advances to block 530.

On the other hand, when the decision in decision block 515 is “YES,” in block 525, the API 122 instructs the application 112 to display the Concierge view page 900 (see FIG. 9), which displays those showtimes for the tagged movies that satisfy the user's user preference(s) specified in the selected user profile 172A. Then, the user 140 advances to block 530.

In block 530, the user 140 uses the Concierge view page 900 (see FIG. 9) to select a movie, a showtime, and optionally selects one or more seats. The user 140 may also select a number of tickets, and a type of ticket if these parameters were not specified in the selected user profile 172A or if the user 140 wishes to choose a different value than is specified in the selected user profile 172A. Then, the user 140 selects the purchase tickets option 930 (see FIG. 9) on the Concierge view page 900 (see FIG. 9).

Next, the method 600 (see FIG. 6) is performed and the method 500 terminates.

FIG. 6 is a flow diagram of the method 600 performed in part by the user 140 (see FIG. 1), in part by the application 112 (see FIG. 1), and in part by the API 122 (see FIG. 1). In first block 635, the API 122 instructs the application 112 to display an order review page (not shown) to the user 140. The order review page (not shown) may include the theatre, time and seat information along with an option to select a payment method. If the user 140 has a positive balance in the user account 152 (see FIG. 1), the user account 152 may be the default payment method. For example, the user account 152 may be preselected as the payment method. The order review page (not shown) also includes a confirm order input (not shown).

In block 640, the user 140 reviews and confirms the ticket order. For example, the user may select the confirm order input (not shown) displayed by the application 112. The application 112 forwards this confirmation to the API 122, Thus, after the user 140 confirms the ticket order, the API 122 receives the ticket order confirmation, The user 140 may elect to use funds the user 140 prepaid into the user account 152.

In block 645, the API 122 forwards payment information to the payment processor service 150 (see FIG. 1), The payment processor service 150 processes the payment information. For example, the payment processor service 150 may deduct costs associated with the ticket order from the user account 152. Then, the payment processor service 150 may send a notification to the API 122.

In decision block 650, the API 122 may receive the notification. If the API 122 receives the notification and the notification indicates that a user error has occurred, the API 122 returns to block 635 and instructs the application 112 to display the order review page (not shown), If the API 122 did not receive the notification (e.g., after a predetermined amount of time) or the notification indicates that a system error has occurred, the API 122 returns to block 645 and resends the payment information to the payment processor service 150 (see FIG. 1). If the API 122 received the notification and the notification indicates payment was successfully processed, in block 655, the API 122 instructs the application 112 to display an order confirmation (not shown). Then, the method 600 terminates,

Referring to FIG. 1, the virtual Concierge service 124 allows users to save their movie-going preferences and tag movies in which they are interested The Concierge view page 900 (see FIG. 9) may display one or more of the tagged movies along with showtimes that have been scored or highlighted to indicate which most closely match the user's saved movie-going preferences. The virtual Concierge service 124 saves a user time by eliminating the need to hunt for showtimes that match the user's individual preferences.

Optionally, the virtual Concierge service 124 may be used to reserve one or more movie tickets for a movie that is not yet playing in theatres. The virtual Concierge service 124 may be characterized as providing an online “fast lane” for moviegoers seeking to avoid online traffic congestion on days when traditional and prior art online ticket purchasing systems often fail. The virtual Concierge service 124 uses pre-collected information about the user 140 and processes transactions on the user's behalf in a batch manner reducing traffic strain on POS systems operated by an exhibitor. For ease of illustration, the virtual Concierge service 124 will be described as reserving movie tickets at the theatre location 160A, which is the exhibitor and operates the POS system 162A. Further, the theatre location 160A will be described as being a participating exhibitor. On the other hand, the theatre location 160B will be described as not being a participating exhibitor.

Instead of camping out in front of a theatre to be first in line, or setting an alarm to be awoken the moment tickets for the latest blockbuster franchise film goes on sale, only to be faced with last mile bandwidth limitations commonly experienced by POS systems operated by exhibitors in high volume situations, the virtual Concierge service 124 acts on the behalf of the user 140 and purchases movie tickets previously reserved by the user 140 allowing the user 140 to avoid stress typically associated with trying to secure highly coveted tickets in limited supply. By compiling committed demand for a particular movie, grouping or consolidating like orders (e.g., having the same theatre, same movie, same showtime, but different seats), and presenting them to a participating exhibitor (e.g., the theatre location 160A) in advance, the virtual Concierge service 124 allows the participating exhibitor to process the reservations in a manner that improves (e.g., maximizes) efficiency. For example, the POS system of the participating exhibitor (e.g., the theatre location 160A) is able to process the consolidated orders, which reduces strain and potential for failure of the POS system and other elements of the system 100, including the virtual Concierge service 124, the API 122, and the application 112.

FIG. 7 is a flow diagram of the method 700 performed in part by the user 140 (see FIG. 1), in part by the application 112 (see FIG. 1), and in part by the API 122 (see FIG. 1). Before the method 700 is performed, the user 140 has selected a movie for which tickets are not currently on sale. In first block 705, the API 122 instructs the application 112 to display the Concierge view page 900 (see FIG. 9). At this point, the Concierge view page 900 cannot yet display showtimes because tickets for the selected movie are not yet on sale. Instead, the user 140 may select a preferred date and time of day. In block 705, the Concierge view page 900 (see FIG. 9) displays date options for the selected movie. If the opening date of the selected movie is known, the date options include specific dates from which the user 140 may select. On the other hand, if the opening date of the selected movie is not known, the date options may specify the opening night, opening weekend, etc. The date options displayed may be in accordance with the user preference(s).

Optionally, the Concierge view page 900 (see FIG. 9) may allow the user 140 to waive (or clear) the user preference(s) to increase the user's chances of being able to reserve and obtain one or more seats. The Concierge view page 900 (see FIG. 9) may allow the user 140 to select a range of dates to increase the user's chances of being able to reserve and obtain one or more seats. Waiving the user preference(s) and/or selecting a range of dates will cause the Concierge view page 900 (see FIG. 9) to update.

In block 710, the user 140 uses the Concierge view page 900 (see FIG. 9) to select reservation parameters. The reservation parameters include one or more of the date options displayed in block 705. The reservation parameters may also include a number of tickets, and a type of ticket. The number of tickets and/or the type of ticket may be determined automatically by the user preference(s). Alternatively, the user 140 may select the number of tickets and/or the type of ticket if these parameters were not specified in the selected user profile 172A or if the user 140 wishes to choose a different value than is specified in the selected user profile 172A. As mentioned above, showtimes are not yet available because tickets for the selected movie are not yet on sale. Therefore, these reserved tickets are for a “to be determined” showtime on a desired date and/or at a desired time.

In optional block 720, the API 122 will instruct the application 112 to display an edit user preferences option (not shown) that, if selected, allows the user 140 to edit the user preference(s) specified in the selected user profile 172A. Then, the API 122 may advance to block 725. For example, the API 122 may instruct the application 112 to display the edit user preferences option (not shown) when the reservation parameters specified by the user 140 in block 710 are inconsistent with the user preference(s) in the selected user profile 172A. Alternatively, if the reservation parameters specified by the user 140 in block 710 are consistent with the user preference(s) in the selected user profile 172A, the API 122 may advance to block 725. By way of another non-limiting example, the API 122 may instruct the application 112 to display the edit user preferences option (not shown) if the user 140 indicates (e.g., clicks on an option indicating) that the user 140 would like to edit the user preference(s). If the optional block 720 is omitted from the method 700, the API 122 advances to block 725 after the block 710.

In block 725, the API 122 instructs the application 112 to display the purchase or reserve tickets option 930 (see FIG. 9) and the application 112 displays the selectable reserve tickets option 930 to the user 140. At this point, the user 140 may select the reserve tickets option 930 on the Concierge view page 900 as the user 140 cannot yet purchase tickets. Many movie studios define an embargo period before a movie is released. During the embargo period, ticket sales are prohibited. The virtual Concierge service 124 provides the reserved movie tickets to the user 140 after the embargo period.

In decision block 730, the API 122 (see FIG. 1) determines whether user 140 selected the reserve tickets option 930 (see FIG. 9). If the user 140 does not select the reserve tickets option 930, in block 735, the user 140 is presented with a ticket reservation page (not shown) and selects another movie for which tickets are not currently on sale. Then, the API 122 returns to block 705 and instructs the application 112 to display the Concierge view page 900 (see FIG. 9) for the newly selected movie.

If the user 140 selects the reserve tickets option 930, in decision block 740, the API 122 determines whether the user 140 has sufficient funds to pay for the tickets being reserved. When the API 122 determines the user 140 does not have sufficient funds to pay for the movie ticket(s), the method 300 is performed and the method 700 terminates. When the API 122 determines the user 140 has sufficient funds to pay for the movie ticket(s), in block 745, the API 122 instructs the application 112 to display a selectable reservation confirmation option (not shown) to the user 140. Then, in block 750, the user 140 selects the reservation confirmation option (not shown) indicating that the user 140 would like to reserve the movie ticket(s).

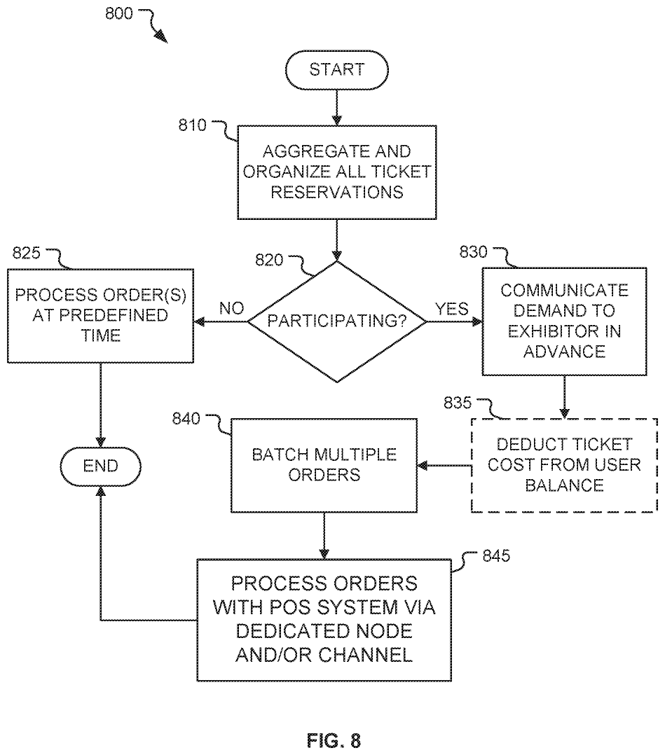

Then, in block 755, the API 122 freezes funds in the user account 152 (see FIG. 1) sufficient to cover the value of the movie ticket(s). In this manner, the user 140 secures the reservation. Freezing the funds effectively collects them in advance and precludes potential issues related to the variable length of time between when users are allowed to make reservations and when the tickets are allowed to be sold. In contrast, a credit card kept on file could be compromised, expire, etc. After the block 755, the method 800 (see FIG. 8) is performed and the method 700 terminates.

FIG. 8 is a flow diagram of the method 800 performed in part by the user 140 (see FIG. 1), in part by the application 112 (see FIG. 1), in part by the API 122 (see FIG. 1), and in part by the Exhibitor. In first block 810, the API 122 aggregates and organizes all of the ticket reservations received from all of the users of the system 100 (see FIG. 1). The API 122 may organize the ticket reservations by exhibitor or theatre, venue, movie, desired showtime, and the like.

The remainder of the method 800 is performed separately for each exhibitor or theatre location for which ticket reservations were received by the virtual Concierge service 124 (see FIG. 1). In decision block 820, the API 122 determines whether the exhibitor is a participating exhibitor. As mentioned above, the theatre location 160A (see FIG. 1) is a participating exhibitor and the theatre location 160B (see FIG. 1) is not a participating exhibitor. The decision in decision block 820 is “NO,” when the API 122 determines the exhibitor is not a participating exhibitor, On the other hand, the decision in decision block 820 is “YES,” when the API 122 determines the exhibitor is a participating exhibitor.

While the virtual Concierge service 124 (see FIG. 1) may collect ticket reservations from the users, those ticket reservations are not processed by the non-participating exhibitor (e.g., the theatre location 160B) until after the sales embargo period is lifted or expires. Thus, when the decision in decision block 820 is “NO,” in block 825, the API 122 processes ticket orders created from the ticket reservations with the POS system 162B (see FIG. 1) at a predefined time after the embargo period is lifted or expires. The API 122 may process those of the ticket orders having the same or similar attributes (e.g., location, date, and showtime) as a batch order. The API 122 automatically distributes seat requests based on the users' preferences. For example, if the virtual Concierge service 124 has ten orders each for two seats in the rear of the auditorium, the virtual Concierge service 124 may consolidate the ten orders into a single order. In this manner, the virtual Concierge service 124 reduces the number of orders that the POS system 162B (see FIG. 1) must process and improves the speed at which such orders may be processed.

If all of the seats specified in a batch order are not available, the virtual Concierge service 124 may remove orders for any seats that the POS system 162B (see FIG. 1) cannot fulfill, Any removed orders may be processed by the virtual Concierge service 124 separately. For example, removed orders may be processed based on their timestamps in the order they were received. If the batch order is unsuccessful (e.g., because the user's first choice for the exhibitor, date, etc. are unavailable), the virtual Concierge service 124 may modify the batch order and reprocess it based on the user's alternate choices (e.g., a different exhibitor, date, etc.).

At this point, if funds were frozen (instead of being collected) in block 750 (see FIG. 7), the API 122 may collect the frozen funds from each of the users' accounts associated with one or more of the ticket orders created from the ticket reservations, In other words, the virtual Concierge service 124 may collect the funds from the user account 152 (see FIG. 1) if they were frozen in block 750 (see FIG. 7). Then, the method 800 terminates.

For example, if the exhibitor of a movie ABC is a non-participating exhibitor, tickets for the movie ABC are scheduled to go on sale December 1, 2019, and showings of the movie ABC will begin on Dec. 31, 2019, the virtual Concierge service 124 may begin taking reservations in October 2019 and may continue to collect reservation until an internal cutoff date prior to Dec. 1, 2019. Payment securing these reservations may be frozen before Dec. 1, 2019. Thus, the virtual Concierge service 124 is able to collect several months' worth of demand data for the movie ABC (along with securing payment for the movie tickets) and submit those orders together as a single batch order.

When the decision in decision block 820 is “YES,” in block 830, the API 122 communicates demand data to the participating exhibitor (e.g., the theatre location 160A depicted in FIG. 1) during the embargo period, which is in advance of expected high order demand. How often the API 122 communicates the demand data to the participating exhibitor (e.g., daily, overnight, once a week, etc.) may be determined by an agreement with the participating exhibitor. The participating exhibitor may use the demand data to anticipate and/or plan for moviegoers. For example, the participating exhibitor may schedule showtimes in a manner consistent with the demand data. The participating exhibitors reserve (or allocate) the reserved seats immediately when the sales embargo period is lifted or expires.

If funds were frozen (instead of being collected) in block 750 (see FIG. 7), in optional block 835, the API 122 deducts the frozen funds from each of the users accounts associated with one or more of the ticket orders created from the ticket reservations. Thus, the virtual Concierge service 124 may collect the funds from the user account 152 (see FIG. 1) that were frozen in block 750 (see FIG. 7). In embodiments in which optional block 835 is omitted, the API 122 advances to block 840 after block 830.

Then, in block 840, the API 122 creates one or more batch orders (e.g., implemented by one or more batch files) each including multiple orders. Each batch order includes those of the ticket orders that have the same or similar attributes (e.g., location, date, and showtime).

Finally, in block 845, the API 122 processes the batch order(s) with the POS system (e.g., the POS system 162A) operated by the exhibitor (e.g., the theatre location 160A). The virtual Concierge service 124 may implement a dedicated node and/or a dedicated communication channel that the virtual Concierge service 124 may use to communicate the batch order(s) with the POS system (e.g., the POS system 162A) operated by the exhibitor (e.g., the theatre location 160A). Then, the method 800 terminates.

For example, if the exhibitor of the movie ABC is a participating exhibitor, tickets for the movie ABC are scheduled to go on sale Dec. 1, 2019, and showings of the movie ABC will begin on Dec. 31, 2019, the virtual Concierge service 124 may begin taking reservations in October 2019 and may continue collecting reservation until an agreed upon cutoff date prior to Dec. 1, 2019. The cutoff date may be agreed upon in advance with the participating exhibitor (e.g., the theatre location 160A). Payment securing these reservations may be frozen or collected before Dec. 1 2019. Before the cutoff date, the virtual Concierge service 124 provides the demand data to the participating exhibitor (e.g., the theatre location 160A), which allows the participating exhibitor to use the predictive demand data (e.g., to schedule showtimes in a manner consistent with the demand data). Additionally, the virtual Concierge service 124 is able to secure payment for the movie tickets and submit the movie ticket orders to the participating exhibitor together as a single batch order. This allows the participating exhibitor (e.g., the theatre location 160A) to more efficiently process the batch orders when compared to processing many separate orders.

Using the methods discussed above, the user 140 may inform the virtual Concierge service 124 (see FIG. 1) of the user's intent to view a blockbuster movie before movie tickets for the blockbuster movie go on sale (e.g., months before the tickets are on sale). The virtual Concierge service 124 uses this information to reserve seats at the exhibitor but the virtual Concierge service 124 does not actually provide the movie tickets to the user 140 because of the sales embargo period.

### Mobile Communication Device

FIG. 10 is a functional block diagram illustrating the mobile communication device 1000 that may be used to implement the client computing device 110 of FIG. 1. By way of non-limiting examples, referring to FIG. 10, the mobile communication device 1000 may be implemented as a cellular telephone, a tablet computer, and the like. The mobile communication device 1000 includes a central processing unit (“CPU”) 1010. Those skilled in the art will appreciate that the CPU 1010 may be implemented as a conventional microprocessor, application specific integrated circuit (“ASIC”), digital signal processor (“DSP”), programmable gate array (“PGA”), or the like. The mobile communication device 1000 is not limited by the specific form of the CPU 1010.

The mobile communication device 1000 also contains the memory 1020. The memory 1020 may store instructions and data to control operation of the CPU 1010. The memory 1020 may include random access memory, ready-only memory, programmable memory, flash memory, and the like. The mobile communication device 1000 is not limited by any specific form of hardware used to implement the memory 1020. The memory 1020 may also be integrally formed in whole or in part with the CPU 1010.

The mobile communication device 1000 also includes conventional components, such as the display device 1030 and one or more user input devices 1040 (e.g., buttons, a keypad, a keyboard, and the like). These are conventional components that operate in a known manner and need not be described in greater detail. The display device 1030 may be implemented as a touch display or touchscreen configured to receive user input (e.g., selections described above with respect to the methods 200-800 illustrated in FIGS. 2-8, respectively, and the like). By way of non-limiting examples, the display device 1030 is operable to display the screens and/or pages (e.g., the Concierge view page 900 illustrated in FIG. 9) and the like.

The mobile communication device 1000 also includes a network transmitter 1050 such as may be used by the mobile communication device 1000 for normal network wireless communication with the network(s) 130 (see FIG. 1), such as with a base station (not shown) of a cellular network. FIG. 10 also illustrates a network receiver 1060 that operates in conjunction with the network transmitter 1050 to communicate with the network(s) 130 (see FIG. 1), such as with the base station (not shown) of the cellular network. In a typical embodiment, the network transmitter 1050 and network receiver 1060 are implemented as a network transceiver 1070. The network transceiver 1070 is connected to an antenna 1080. Operation of the network transceiver 1070 and the antenna 1080 for communication with the network(s) 130 (see FIG. 1) is well-known in the art and need not be described in greater detail herein.

Returning to FIG. 10, other conventional components found in wireless communication devices, such as a USB interface, Bluetooth interface, camera/video device, infrared device, global positioning system (“GPS”) device, and the like, may also be included in the mobile communication device 1000. For the sake of clarity, these conventional elements are not illustrated in the functional block diagram of FIG. 10. The GPS device may be used to determine the current geographic location (e.g., latitude and longitude) of the mobile communication device 1000.

The various components illustrated in FIG. 10 are coupled together by a bus system 1090. The bus system 1090 may include an address bus, data bus, power bus, control bus, and the like. For the sake of convenience, the various busses in FIG. 10 are illustrated as the bus system 1090.

In some embodiments, the memory 1020 stores computer executable instructions that when executed by one or more processors (e.g., the CPU 1010) cause the one or more processors to implement the application 112 and/or perform all or portions of one or more of the methods (including the methods 200-800 illustrated in FIG. 2-8, respectively) described above. Such instructions may be stored on one or more non-transitory computer-readable media.

The memory 1020 stores computer executable instructions that when executed by the CPU 1010 cause the CPU 1010 to generate the screens and/or pages (e.g., the Concierge view page 900 illustrated in FIG. 9) described above and displayed by the display device 1030. Such instructions may be stored on one or more non-transitory computer-readable media. The screens and/or pages (e.g., the Concierge view page 900 illustrated in FIG. 9) described above and displayed by the display device 1030 may each be characterized as being a graphical user interface.

### Computing Device

FIG. 11 is a diagram of hardware and an operating environment in conjunction with which implementations of the one or more computing devices of the system 100 may be practiced. The description of FIG. 11 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those of ordinary skill in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments (e.g., cloud computing platforms) where tasks are performed by remote processing devices that are linked through a communications network. In a distributed computing environment, program modules may be located in both local and remote memory storage devices.

The exemplary hardware and operating environment of FIG. 11 includes a general-purpose computing device in the form of the computing device 12. Each of the computing devices of FIG. 1 (including the client computing device 110, the server computing device 120, and the computing device implementing the payment processor service 150) may be substantially identical to the computing device 12. By way of non-limiting examples, the computing device 12 may be implemented as a laptop computer, a tablet computer, a web enabled television, a personal digital assistant, a game console, a smartphone, a mobile computing device, a cellular telephone, a desktop personal computer, and the like.

The computing device 12 includes the system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those of ordinary skill in the art that any type of computer-readable media which can store data that is accessible by a computer, such as magnetic cassettes, flash memory cards, solid state memory devices (“SSD”), USB drives, digital video disks, Bernoulli cartridges, random access memories (RAMS), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including the operating system 35, one or more application programs 36, other program modules 37, and program data 38. A user may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A display device 47, such as a monitor, a touch display, a touchscreen, or other type of display device, is also connected to the system bus 23 via an interface, such as a video adapter 48. In addition to the display device 47, computers typically include other peripheral output devices (not shown), such as speakers, printers, and haptic devices that provide tactile and/or other types of physical feedback (e.g., a force feed back game controller).

The input devices described above are operable to receive user input and selections. Together the input and display devices may be described as providing a user interface.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12, The remote computer 49 may be connected to a memory storage device 50. The logical connections depicted in FIG. 11 include a local-area network (LAN) 51 and a wide-area network (WAN) 52, Such networking environments are commonplace in offices, enterprise-wide computer networks, intranets and the Internet, The network(s) 130 (see FIG. 1) may be implemented using one or more of the LAN 51 or the WAN 52 (e.g., the Internet).

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port), Further, many laptop computers may connect to a network via a cellular data modem,

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 22 stores computer executable instructions that when executed by one or more processors (e.g., the processing unit 21) cause the one or more processors to implement one or more applications (e.g., the application 112, the API 122, and the virtual Concierge service 124 illustrated in FIG. 1) and/or perform all or portions of one or more of the methods (including the methods 200-800 illustrated in FIGS. 2-8, respectively) described above. Such instructions may be stored on one or more non-transitory computer-readable media.

In some embodiments, the system memory 22 stores computer executable instructions that when executed by one or more processors (e.g., the processing unit 21) cause the one or more processors to generate the screens and/or pages (e.g., the Concierge view page 900 illustrated in FIG. 9) described above and displayed by the display device 47. Such instructions may be stored on one or more non-transitory computer-readable media. The screens and/or pages (e.g., the Concierge view page 900 illustrated in FIG. 9) described above and displayed by the display device 47 may each be characterized as being a graphical user interface.

Embodiments of the present disclosure can be described in view of the following clauses:

1. A computer-implemented method comprising:

identifying, by a concierge service implemented by at least one server computing device, a user profile storing user preferences associated with a user operating a client computing device;

using, by the concierge service, the user preferences to identify a plurality of showtimes for a movie;

instructing, by the concierge service, the client computing device to display a graphical user interface to the user, the graphical user interface displaying the plurality of showtimes and comprising a plurality of selectable user inputs each associated with a corresponding one of the plurality of showtimes;

receiving, by the concierge service, an indication that the user has selected a particular one of the plurality of selectable user inputs corresponding to a particular showtime; and

completing, by the concierge service, a purchase of at least one movie ticket for the particular showtime.

2. The computer-implemented method of clause 1, wherein the concierge service uses the user preferences to identify the plurality of showtimes for the movie without having received any additional input from the user.

3. The computer-implemented method of clause 1 or 2, wherein the user profile is a selected one of a plurality of user profiles associated with the user, and

identifying the selected user profile comprises receiving, by the concierge service, user information from the client computing device comprising an identification of the selected user profile.

4. The computer-implemented method of any of clauses 1-3, wherein the user preferences comprise an identification of the movie, a time of day, and a theatre location, and

the concierge service uses the user preferences to identify the plurality of showtimes as those movie showtimes that match the time of day and are for the movie at the theatre location.

5. The computer-implemented method of clause 4, wherein the user preferences comprise an identification of preferred seating, and

the concierge service uses the user preferences to identify the plurality of showtimes as those movie showtimes that have the preferred seating available, match the time of day, and are for the movie at the theatre location.

6. The computer-implemented method of any of clauses 1-5, wherein the user preferences comprise a selection of a movie option, and

the concierge service uses the user preferences to identify the plurality of showtimes as those movie showtimes for the movie that match the selection.

7. The computer-implemented method of clause 6, wherein the movie option comprises whether the movie is in three-dimensions (“3D”) or whether the movie is in IMAX format.

8. The computer-implemented method of any of clauses 1-7, further comprising:

receiving, by the concierge service, an indication that the user is interested in purchasing one or more tickets for the movie; and

storing, by the concierge service, an indication in the user preferences that the user is interested in purchasing one or more tickets for the movie.

9. The computer-implemented method of any of clauses 1-8, further comprising:

instructing, by the concierge service, the client computing device to display a confirmable ticket order before the concierge service completes the purchase, the confirmable ticket order comprising the particular showtime, a theatre location, seat information, and an identification of a payment method; and

receiving, by the concierge service, a confirmation of the confirmable ticket order from the client computing device before the concierge service completes the purchase.

10. The computer-implemented method of any of clauses 1-9, wherein the graphical user interface displays an indicator for each of the plurality of showtimes indicating how closely the showtime matches the user preferences.

11. A computer-implemented method comprising:

receiving, by a concierge service implemented by at least one server computing device, funds from a user;

receiving, by the concierge service, an indication that the user would like to reserve at least one movie ticket for a movie that has not yet been released and for which tickets are not yet available for purchase;

identifying, by the concierge service, a preferred theatre location, a date, and a time of day;

receiving, by the concierge service, an indication that the user would like to reserve at least one movie ticket for the movie at the preferred theatre location on the date and at the time of day;

freezing, by the concierge service, a portion of the funds corresponding to a price of the at least one movie ticket when the movie has not yet been released to thereby create a ticket reservation;

purchasing, by the concierge service, the at least one movie ticket for the user from the preferred theatre location after the tickets are made available for purchase; and

collecting, by the concierge service, the portion of the funds that were frozen.

12. The computer-implemented method of clause 11, wherein the concierge service identifies the preferred theatre location, the date, and the time of day by identifying a user profile associated with the user, the user profile storing the preferred theatre location, the date, and the time of day.

13. The computer-implemented method of clause 11 or 12, wherein the concierge service identifies the preferred theatre location and the time of day by identifying a user profile associated with the user, the user profile storing the preferred theatre location and the time of day, and the computer-implemented method further comprises:

instructing, by the concierge service, a client computing device operated by the user to display date options, a selected one of the date options identifying the date to the concierge service when the selected date option is selected by the user.

14. The computer-implemented method of any of clauses 11-13, further comprising:

identifying, by the concierge service, a user profile associated with the user, the user profile identifying a number of movie tickets and a type of movie ticket; and

identifying, by the concierge service, the at least one movie ticket based on the number of movie tickets and the type of movie ticket.

15. The computer-implemented method of any of clauses 11-14, further comprising:

consolidating, by the concierge service, the ticket reservation with other ticket reservations for the movie at the preferred theatre location when purchasing the at least one movie ticket to thereby reduce a number of ticket orders that the preferred theatre location must process.

16. The computer-implemented method of any of clauses 11-15, further comprising:

communicating, by the concierge service, demand data to the preferred theatre location before the tickets are made available for purchase to thereby allow the preferred theatre location to plan for demand for the movie.

17. A system comprising:

at least one server computing device implementing a concierge service configured to access a user profile storing user preferences, the user profile being associated with a user; and

a client computing device comprising a display device and implementing a user application operable by the user, the user application being operable to receive a selection of the user profile from the user and forward the selection to the concierge service, the concierge service being configured to use the user preferences stored by the user profile to identify a showtime for a movie without additional user input and cause the display device to display a graphical user interface to the user, the graphical user interface displaying the showtime and comprising a selectable user input that, when selected by the user, indicates the user would like to purchase at least one movie ticket for the showtime, the user application being operable to transmit an indication to the concierge service that the selectable user input has been selected, the concierge service being configured to complete a purchase of the at least one movie ticket.

18. The system of clause 17, further comprising:

one or more computing devices implementing a payment processor service, the concierge service being configured to complete the purchase by forwarding a cost of the at least one movie ticket to the payment processor service, the payment processor service being configured to deduct the cost from a user account associated with the user.

19. The system of clause 17or 18, wherein the user profile is a selected one of a plurality of user profiles associated with the user, and

the concierge service receives user information identifying the selected user profile from the client computing device.

20. The system of any of clauses 17-19, wherein the user preferences comprise an identification of the movie, a time of day, and a theatre location, and

the concierge service uses the user preferences to identify the showtime at the theatre location for the movie that matches the time of day.

21. The system of clause 20, wherein the user preferences comprise an identification of preferred seating, and

the concierge service uses the user preferences to identify the showtime for the movie at the theatre location that matches the time of day and has the preferred seating available.

The foregoing described embodiments depict different components contained within, or connected with, different other components. It is to be understood that such depicted architectures are merely exemplary, and that n fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or at least one and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Conjunctive language, such as phrases of the form “at least one of A, B, and or C,” “at least one of A, B and C,” (i.e., the same phrase with or without the Oxford comma) unless specifically stated otherwise or otherwise clearly contradicted by context, is otherwise understood with the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B, and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context.

Accordingly, the invention is not limited except as by the appended claims.

1. A computer-implemented method comprising:
identifying, by a concierge service implemented by at least one server computing device, a user profile storing user preferences associated with a user operating a client computing device;
using, by the concierge service, the user preferences to identify a plurality of showtimes for a movie;
instructing, by the concierge service, the client computing device to display a graphical user interface to the user, the graphical user interface displaying the plurality of showtimes and comprising a plurality of selectable user inputs each associated with a corresponding one of the plurality of showtimes;
receiving, by the concierge service, an indication that the user has selected a particular one of the plurality of selectable user inputs corresponding to a particular showtime; and
completing, by the concierge service, a purchase of at least one movie ticket for the particular showtime.

2. The computer-implemented method of claim 1, wherein the concierge service uses the user preferences to identify the plurality of showtimes for the movie without having received any additional input from the user.

3. The computer-implemented method of claim 1, wherein the user profile is a selected one of a plurality of user profiles associated with the user, and
identifying the selected user profile comprises receiving, by the concierge service, user information from the client computing device comprising an identification of the selected user profile.

4. The computer-implemented method of claim 1, wherein the user preferences comprise an identification of the movie, a time of day, and a theatre location, and
the concierge service uses the user preferences to identify the plurality of showtimes as those movie showtimes that match the time of day and are for the movie at the theatre location.

5. The computer-implemented method of claim 4, wherein the user preferences comprise an identification of preferred seating, and
the concierge service uses the user preferences to identify the plurality of showtimes as those movie showtimes that have the preferred seating available, match the time of day, and are for the movie at the theatre location.

6. The computer-implemented method of claim 1, wherein the user preferences comprise a selection of a movie option, and
the concierge service uses the user preferences to identify the plurality of showtimes as those movie showtimes for the movie that match the selection.

7. The computer-implemented method of claim 6, wherein the movie option comprises whether the movie is in three-dimensions (“3D”) or whether the movie is in IMAX format.

8. The computer-implemented method of claim 1, further comprising:
receiving, by the concierge service, an indication that the user is interested in purchasing one or more tickets for the movie; and
storing, by the concierge service, an indication in the user preferences that the user is interested in purchasing one or more tickets for the movie.

9. The computer-implemented method of claim 1, further comprising:
instructing, by the concierge service, the client computing device to display a confirmable ticket order before the concierge service completes the purchase, the confirmable ticket order comprising the particular showtime, a theatre location, seat information, and an identification of a payment method; and
receiving, by the concierge service, a confirmation of the confirmable ticket order from the client computing device before the concierge service completes the purchase.

10. The computer-implemented method of claim 1, wherein the graphical user interface displays an indicator for each of the plurality of showtimes indicating how closely the showtime matches the user preferences.

11. A computer-implemented method comprising:
receiving, by a concierge service implemented by at least one server computing device, funds from a user;
receiving, by the concierge service, an indication that the user would like to reserve at least one movie ticket for a movie that has not yet been released and for which tickets are not yet available for purchase;
identifying, by the concierge service, a preferred theatre location, a date, and a time of day;
receiving, by the concierge service, an indication that the user would like to reserve at least one movie ticket for the movie at the preferred theatre location on the date and at the time of day;
freezing, by the concierge service, a portion of the funds corresponding to a price of the at least one movie ticket when the movie has not yet been released to thereby create a ticket reservation;
purchasing, by the concierge service, the at least one movie ticket for the user from the preferred theatre location after the tickets are made available for purchase; and
collecting, by the concierge service, the portion of the funds that were frozen.

12. The computer-implemented method of claim 11, wherein the concierge service identifies the preferred theatre location, the date, and the time of day by identifying a user profile associated with the user, the user profile storing the preferred theatre location, the date, and the time of day.

13. The computer-implemented method of claim 11, wherein the concierge service identifies the preferred theatre location and the time of day by identifying a user profile associated with the user, the user profile storing the preferred theatre location and the time of day, and the computer-implemented method further comprises:
instructing, by the concierge service, a client computing device operated by the user to display date options, a selected one of the date options identifying the date to the concierge service when the selected date option is selected by the user.

14. The computer-implemented method of claim 11, further comprising:
identifying, by the concierge service, a user profile associated with the user, the user profile identifying a number of movie tickets and a type of movie ticket; and
identifying, by the concierge service, the at least one movie ticket based on the number of movie tickets and the type of movie ticket.

15. The computer-implemented method of claim 11, further comprising:
consolidating, by the concierge service, the ticket reservation with other ticket reservations for the movie at the preferred theatre location when purchasing the at least one movie ticket to thereby reduce a number of ticket orders that the preferred theatre location must process.

16. The computer-implemented method of claim 11, further comprising:
communicating, by the concierge service, demand data to the preferred theatre location before the tickets are made available for purchase to thereby allow the preferred theatre location to plan for demand for the movie.

17. A system comprising:
at least one server computing device implementing a concierge service configured to access a user profile storing user preferences, the user profile being associated with a user; and
a client computing device comprising a display device and implementing a user application operable by the user, the user application being operable to receive a selection of the user profile from the user and forward the selection to the concierge service, the concierge service being configured to use the user preferences stored by the user profile to identify a showtime for a movie without additional user input and cause the display device to display a graphical user interface to the user, the graphical user interface displaying the showtime and comprising a selectable user input that, when selected by the user, indicates the user would like to purchase at least one movie ticket for the showtime, the user application being operable to transmit an indication to the concierge service that the selectable user input has been selected, the concierge service being configured to complete a purchase of the at least one movie ticket.

18. The system of claim 17, further comprising:
one or more computing devices implementing a payment processor service, the concierge service being configured to complete the purchase by forwarding a cost of the at least one movie ticket to the payment processor service, the payment processor service being configured to deduct the cost from a user account associated with the user.

19. The system of claim 17, wherein the user profile is a selected one of a plurality of user profiles associated with the user, and
the concierge service receives user information identifying the selected user profile from the client computing device.

20. The system of claim 17, wherein the user preferences comprise an identification of the movie, a time of day, and a theatre location, and
the concierge service uses the user preferences to identify the showtime at the theatre location for the movie that matches the time of day.

21. The system of claim 20, wherein the user preferences comprise an identification of preferred seating, and
the concierge service uses the user preferences to identify the showtime for the movie at the theatre location that matches the time of day and has the preferred seating available.
